(19) United States
(12) Patent Application Publication
(10) Pub. No.: US 2013/0056404 A1
(43) Pub. Date: Mar. 7, 2013

(54) WATER DESALINATION PLANT, IN PARTICULAR SEAWATER DESALINATION PLANT, AND CONNECTOR FOR A TUBE OF SUCH A PLANT

(71) Applicants: Jean-Luc Malige, Courbevoie (FR); Jérôme Arnaudis, Paris (FR); Emmanuel Maschas, Paris (FR)

(72) Inventors: Jean-Luc Malige, Courbevoie (FR); Jérôme Arnaudis, Paris (FR); Emmanuel Maschas, Paris (FR)

(73) Assignee: Degremont, Paris La Defense (FR)

(21) Appl. No.: 13/640,537

(22) PCT Filed: Apr. 12, 2011
(86) PCT No.: PCT/IB11/51564

§ 371 Date: Nov. 16, 2012

(30) Foreign Application Priority Data
Apr. 14, 2010 (FR) 1052835

(51) Int. Cl. B01D 63/06; F16L 41/02; C02F 1/44; C02F 103/08

(52) U.S. Cl. 210/321.8; 285/133.11

(57) ABSTRACT

Plant for water desalination, in particular seawater desalination, using reverse-osmosis membranes arranged inside pressure tubes in which the water to be treated is introduced under high pressure, a plurality of tubes (1.1, 1.2, 1.3, 1.4) being arranged in parallel, each tube comprising a removable end cap (5) having a permeate outlet equipped with a connector (4), a permeate manifold (6) being connected to the connectors of the various tubes by a flexible line (7) assigned to each connector; the manifold (6) is situated beyond the ends of the tubes (1.1, 1.2, 1.3, 1.4), outside the space contained between planes (P1, P2) passing through the end faces of the tubes, and comprises, for each pressure tube, a connection nozzle (8.1, 8.2) directed towards the opposite side to the pressure tube, the flexible connection line (7) between the connector (4) of the pressure tube and the nozzle (8.1, 8.2) describing a loop (B) of at least 180 DEG.

The invention relates to an installation for desalination of water, in particular seawater, by means of reverse osmosis membranes which are arranged inside pressure tubes into which the water to be treated is introduced under high pressure, a plurality of tubes being arranged in parallel, in particular according to superimposed horizontal layers, each tube comprising a removable end cap which is provided with a permeate outlet equipped with a connector, a permeate manifold being connected to the connectors of the different tubes by a flexible line which is dedicated to each connector.

The reverse osmosis consists of making salt water penetrate into pressure tubes containing semi-permeable reverse osmosis membranes, under a pressure which is higher than the osmotic pressure, such that a fraction of the water passes through the membrane in order to provide the permeate which then contains virtually no more salt, whereas the dissolved salts remain in the other part of the water, which is designated by the term “concentrate”. The permeate which is discharged from the pressure tubes is at a reduced pressure, which is substantially atmospheric pressure.

The introduction pressure of the water to be treated can be approximately 80 bars, because of the high osmotic pressure. The pressure tubes are generally made of resin reinforced with glass fibers, for reasons of cost and resistance to corrosion by the sea water. Under the effect of this high pressure, the tubes dilate, whereas the lines which collect the permeate are retained by a structure or frame which is generally made of metal, and are fixed.

Because of the expansion of the tubes under the effect of the pressure, the end of a tube comprising the permeate outlet can be displaced by several millimeters, depending on whether or not pressurized water to be treated is introduced into the pressure tube. It is therefore appropriate to provide, between the permeate outlet and the fixed collector, a connection device which makes it possible to absorb the displacements of the end of the pressure tube relatively to the manifold. Thus, provision has been made for the use either of rigid or semi-rigid lines with a small diameter, sometimes provided with connectors which permit a certain displacement, or for flexible lines to be put into place.

The implantation of flexible lines of this type is relatively complicated and problematic, since it is necessary to be able to open the end of each pressure tube in order to change the reverse osmosis membranes when this is necessary. During these operations, as well as during the functioning of the installation, it is necessary to avoid pinching the flexible lines, otherwise their service life is considerably reduced accordingly. It is desirable for the implantation of the flexible lines not to give rise to a significant increase in the dimensions of the pressure tubes, which in a large installation can be several thousand in number, arranged in superimposed horizontal layers.

In order to solve this problem and facilitate the fitting of the tubes whilst assuring a satisfactory service life of the flexible lines, according to the invention a water desalination installation of the type previously defined is characterized in that:
the manifold is situated beyond the ends of the tubes, outside the space contained between planes which pass via the end surfaces of the tubes; and
for each pressure tube, the manifold comprises a connection nozzle which faces the side opposite the pressure tube, and the flexible connection line between a pressure tube connector and a nozzle describes a loop of at least 180°.

According to another presentation of the invention, the flexible permeate outlet lines are arranged such that:
they form a loop of at least 180°;
the loops are arranged such that it is possible to release a tube end cap which forms a pressure head, and remove the membranes from the pressure tube concerned, without needing to remove other flexible lines.

The angle which is described by the loop is defined as the angle formed between the tangents at the ends of the flexible line which are connected to the connector of the tube and to the nozzle.

Preferably, the loop which is described by the flexible line is at least 225°.

Advantageously, each loop which is described by a flexible line has a mean plane which is oblique relative to the plane which passes via the geometric axis of the pressure tube, and at right-angles to the manifold, such that the nozzle of the manifold which is associated with a tube is offset transversely relative to the outlet connector of this pressure tube. Consequently, when the cap is removed, access to the interior of the pressure tube is left clear.

Advantageously, each nozzle of the manifold is situated substantially at the same distance from two adjacent tubes in a single row.

In general, the pressure tubes are horizontal and parallel, superimposed in layers, and a manifold is provided for two successive layers, this manifold extending parallel to the plane of each layer in an intermediate position, substantially halfway from each layer. The nozzles of the manifold which are designed for the upper layer are inclined upwards, on the side opposite the tubes, whereas the nozzles which are designed for the lower layer are inclined downwards on the side opposite the tubes.

Preferably, the connector which is provided on the end cap of each tube comprises a lateral outlet, in particular at right-angles, to which there is connected the flexible line for the permeate, and an axial outlet with a sleeve in which there is fitted a hose with a reduced diameter for taking of samples. The hose for taking of samples can be fitted so as to slide parallel to the axis of the tube, in a sealed manner, such that samples can be taken at different axial positions inside the tube.

The invention also relates to a connector for an end cap of a pressure tube of an installation such as previously defined, characterized in that it comprises a lateral outlet, in particular at right-angles, for the connection of a line for discharge of the permeate, and an axial outlet with a sleeve in which there is fitted a hose with a reduced diameter in order to permit taking of samples at different axial positions inside the tube.

In addition to the above-described arrangements, the invention consists of a certain number of other arrangements which will be discussed explicitly hereinafter with reference to an embodiment described in relation to the appended drawing, but which is in no way limiting. In this drawing:

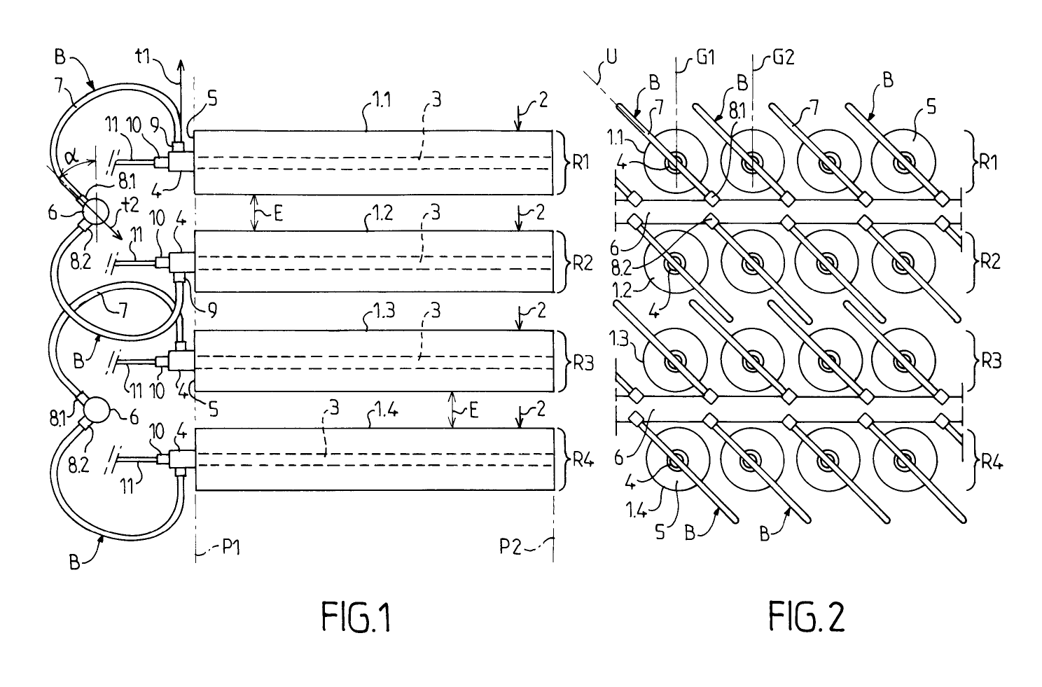

FIG. 1 is a partial schematic elevated view of a water desalination installation according to the invention; and

FIG. 2 is a partial view of the installation from the left relative to FIG. 1.

The drawing shows an installation for desalination of water, in particular seawater, by means of reverse osmosis membranes (not shown) arranged inside pressure tubes 1.1, 1.2, 1.3, 1.4 which are generally made of composite materials consisting of a resin reinforced with glass fibers. The tubes 1.1, 1.2, 1.3, 1.4 are arranged in rows which form horizontal layers R1, R2, R3, R4. Only four layers have been represented for the sake of simplification, but their number is not limited. The geometric axes of the tubes in a single row are parallel and situated on the same horizontal plane. The vertical distance which determines the free space between two layers is designated by the letter E. The tubes 1 are supported by a structure not represented, with the possibility of expansion, substantially in the longitudinal direction.

The water to be treated is introduced at a point 2 towards an end of each tube under high pressure, in particular approximately 80 bars, which is higher than the osmotic pressure of the membranes of the tube. A plurality of reverse osmosis membranes, which are generally wound in spirals, are arranged inside each tube 1.1 . . . 1.4. The permeate outlet of the membranes is connected to an inner axial channel 3 which is connected to an outlet provided with a connector 4 which is provided at the end of the tube opposite the inlet 2. The permeate is discharged virtually at atmospheric pressure. The connector 4 is fitted on a removable end cap 5 represented schematically, which makes it possible to access the inside of the tube 1 for replacement of membranes if necessary,

The permeate is received by a manifold 6 which is connected to each outlet connector 4 of a tube by a flexible line 7. The manifold 6 is generally constituted by a duct arranged in a plane parallel to the layers, according to a direction at right-angles to the geometric axes of the tubes. The manifold 6 is retained fixed on the support structure of the installation; in these conditions, the displacements of the ends of the tubes 1.1 . . . 1.4 caused by the high injection pressure give rise to displacements of the connectors 4 relative to the manifold 6, which displacements the line 7 must be able to absorb. The dissolved salts remain in the other part of the water which forms the concentrate discharged via an outlet not represented in the drawing.

A seawater desalination installation can comprise several thousand tubes 1.1 . . . 1.4 which are arranged in numerous horizontal layers, and the dimensions of the assembly depend in particular on the distance E between two superimposed layers, which must be reduced as far as possible.

According to the invention, in order to leave clear the area contained between the layers, the manifold 6 is situated beyond the ends of the tubes which are provided with the caps 5, outside the space contained between planes P1, P2 which pass via the end surfaces, which are generally coplanar, of the tubes.

In addition, for each pressure tube, the manifold 6 comprises a connection nozzle 8.1, 8.2 which faces the side opposite the pressure tube, and the flexible connection line 7 between the connector 4 of the pressure tube and the nozzle 8.1, 8.2 describes a loop B of at least 180°.

The angular path of the loop B is defined as the angle formed between the tangents t1 and t2 at the connection ends of the flexible line 7, respectively and with the connector 4 and with the nozzle 8.1, 8.2. As can be seen in FIG. 1, the tangent t1 turns by more than 180° to go to the position t2.

With an arrangement of this type, the flexible line 7 can have a large radius of curvature, and a length which is long enough to prevent pinching of the hose during displacements of the tube, which facilitates the fitting and removal of the end cap 5.

Preferably, the nozzle 8 is oriented on the side opposite the tube, according to an angle a of at least 45° relative to the vertical, such that the loop B describes a path of at least 225°.

The connector 4 comprises a lateral outlet 9, at right-angles relative to the geometric axis of the tube, for the permeate, and an axial sleeve 10 for fitting of a hose 11 with a reduced diameter, which allows a sample to be taken inside the tube 1.1 . . . 1.4.

The taking of a sample makes it possible to carry out a measurement of conductivity, in order to evaluate the efficiency of the filtering provided by the membranes of the tube.

Preferably, the hose 11 is connected at its other end to a centralized sample panel. The operator can thus identify whether a tube is supplying water with conductivity which is too high.

When a defective tube is identified, the hose 11 is disconnected from the sleeve 10, and is replaced by an adaptor which permits the introduction of a relatively rigid rod, which itself is connected to a portable conductivity analyzer; the rod is introduced progressively at different axial positions corresponding to different membranes which are accommodated inside the tube 1.1 . . . 1.4. When the conductivity becomes normal once more, this is because the rod has passed beyond the element containing the leak; the leak is thus localized.

Advantageously, each manifold 6 is designed to receive the permeate of two layers of tubes, for example R1, R2. The height of the manifold 6 is offset relative to each of the layers, and is situated substantially halfway from each layer, i.e. it is lower than the upper layer R1 and higher than the lower layer R2.

The nozzles 8.1 which are designed for the tubes 1.1 of the upper layer R1 are upwardly oblique, whereas the nozzles 8.2 which are designed for the lower layer R2 are downwardly oblique.

In addition, as can be seen in FIG. 2, the nozzle 8.1 which is designed for a tube 1.1 is offset transversely relative to the vertical plane G1 which passes via the geometric axis of the associated tube. Thus, the mean plane U of the loop B is oblique relative to the plane G1 which is at right-angles to the geometric axis of the manifold 6. Preferably, the nozzle 8.1 is substantially halfway between the vertical planes G1, G2 of adjacent tubes 1.1 in a single layer.

Thus, when the end cap of a tube such as 1.1 is removed, the flexible line 7 can be suspended whilst being retained by the nozzle 8.1 and whilst supporting the end cap, without impeding access to a lower tube end cap, or removal of the latter. Access to the inside of the tube 1.1 is left entirely clear.

The loops B for connection of all the tubes thus have inclination, as illustrated in FIG. 2, according to the same angle relative to the vertical. The maintenance operations are facilitated, all the more so since the hoses 11 for taking of samples are rendered integral with the permeate outlet hoses 7, this also contributing towards facilitating these maintenance operations.

1-11. (canceled)

12. An installation for desalination of water, in particular seawater, having reverse osmosis membranes which are arranged inside pressure tubes into which the water to be treated is introduced under high pressure, a plurality of tubes being arranged in parallel, each tube comprising a removable end cap which is provided with a permeate outlet equipped with a connector, a permeate manifold being connected to the connectors of the different tubes by a flexible line which is dedicated to each connector, wherein:
the manifold is situated beyond the ends of the tubes, outside the space contained between planes (P1, P2) which pass via the end surfaces of the tubes; and
for each pressure tube, the manifold comprises a connection nozzle which faces the side opposite the pressure tube, and the flexible connection line between the pressure tube connector and the nozzle describes a loop (B) of at least 180°.

13. The installation as claimed in claim 12, wherein the loop which is described by the flexible line is at least 225°.

14. The installation as claimed in claim 12, wherein the pressure tubes are arranged according to superimposed horizontal layers (R1, R2, R3, R4).

15. The installation as claimed in claim 12, wherein each loop (B) which is described by a flexible line has a mean plane (U) which is oblique relative to the plane (G1) which passes via the geometric axis of the pressure tube, and at right-angles to the manifold, such that the nozzle of the manifold which is associated with a tube is offset transversely relative to the outlet connector of this pressure tube.

16. The installation as claimed in claim 15, wherein the nozzle of the manifold is situated substantially at the same distance from two adjacent tubes in a single row.

17. The installation as claimed in claim 12, wherein the pressure tubes are horizontal and parallel, superimposed in layers, and wherein a manifold is provided for two successive layers (R1, R2), this manifold extending parallel to the plane of each layer in an intermediate position, substantially halfway from each layer.

18. The installation as claimed in claim 17, wherein the nozzles of the manifold which are designed for the upper layer (R1) are inclined upwards, on the side opposite the tubes, whereas the nozzles which are designed for the lower layer (R2) are inclined downwards on the side opposite the tubes.

19. The installation as claimed in claim 12, wherein the connector which is provided on the end cap of each tube comprises a lateral outlet, in particular at right-angles, to which there is connected the flexible line for the permeate, and an axial outlet with a sleeve in which there is fitted a hose with a reduced diameter for taking of samples.

20. The installation as claimed in claim 19, wherein the hose for taking of samples is fitted so as to slide parallel to the axis of the tube, in a sealed manner, so that samples can be taken at different axial positions inside the tube.

21. A connector for an end cap of a pressure tube of an installation according to claim 12, further comprising a lateral outlet, in particular at right-angles, for the connection of a line for discharge of the permeate, and an axial outlet with a sleeve in which there is fitted such as to slide a hose in order to permit taking of samples at different axial positions inside the tube.

22. The installation for desalination of water, in particular seawater, having reverse osmosis membranes which are arranged inside pressure tubes into which the water to be treated is introduced under high pressure, a plurality of tubes being arranged in parallel, each tube comprising a removable end cap which is provided with a permeate outlet equipped with a connector, a permeate manifold being connected to the connectors of the different tubes by a flexible line which is dedicated to each connector, wherein the flexible permeate outlet lines are arranged such that:
they form a loop (B) of at least 180°;
the loops (B) are arranged such that it is possible to release a tube end cap which forms a pressure head, and remove the membranes from the pressure tube concerned, without needing to remove other flexible lines.

23. The installation as claimed in claim 22, wherein the loop which is described by the flexible line is at least 225°.

24. The installation as claimed in claim 22, wherein the pressure tubes are arranged according to superimposed horizontal layers (R1, R2, R3, R4).

25. The installation as claimed in claim 22, wherein each loop (B) which is described by a flexible line has a mean plane (U) which is oblique relative to the plane (G1) which passes via the geometric axis of the pressure tube, and at right-angles to the manifold, such that the nozzle of the manifold which is associated with a tube is offset transversely relative to the outlet connector of this pressure tube.

26. The installation as claimed in claim 25, wherein the nozzle of the manifold is situated substantially at the same distance from two adjacent tubes in a single row.

27. The installation as claimed in claim 22, wherein the pressure tubes are horizontal and parallel, superimposed in layers, and wherein a manifold is provided for two successive layers (R1, R2), this manifold extending parallel to the plane of each layer in an intermediate position, substantially halfway from each layer.

28. The installation as claimed in claim 27, wherein the nozzles of the manifold which are designed for the upper layer (R1) are inclined upwards, on the side opposite the tubes, whereas the nozzles which are designed for the lower layer (R2) are inclined downwards on the side opposite the tubes.

29. The installation as claimed in claim 22, wherein the connector which is provided on the end cap of each tube comprises a lateral outlet, in particular at right-angles, to which there is connected the flexible line for the permeate, and an axial outlet with a sleeve in which there is fitted a hose with a reduced diameter for taking of samples.

30. The installation as claimed in claim 29, wherein the hose for taking of samples is fitted so as to slide parallel to the axis of the tube, in a sealed manner, so that samples can be taken at different axial positions inside the tube.

31. A connector for an end cap of a pressure tube of an installation according to claim 22, further comprising a lateral outlet, in particular at right-angles, for the connection of a line for discharge of the permeate, and an axial outlet with a sleeve in which there is fitted such as to slide a hose in order to permit taking of samples at different axial positions inside the tube.
